(19) United States
(12) Patent Application Publication
(10) Pub. No.: US 2023/0127764 A1
(43) Pub. Date: Apr. 27, 2023

(54) IMAGE FORMING APPARATUS CAPABLE OF SUPPRESSING HIGH TEMPERATURE IN ELECTROSTATIC NEUTRALIZING MEMBER

(71) Applicant: KYOCERA Document Solutions Inc., Osaka (JP)

(72) Inventor: Hironori Yamauchi, Osaka (JP)

(21) Appl. No.: 17/972,405

(22) Filed: Oct. 24, 2022

(30) Foreign Application Priority Data
Oct. 27, 2021 (JP) 2021-175222

(51) Int. Cl. G03G 15/00; G03G 15/20

(52) U.S. Cl. CPC G03G 15/80; G03G 15/2053

(57) ABSTRACT

An image forming apparatus includes a fixing member, an electrostatic neutralizing member, a heater, and a melting portion. The fixing member comes into contact with a sheet to which a toner image has been transferred and fixes the toner image to the sheet. The electrostatic neutralizing member is electrically grounded and provided so as to be in contact with the fixing member. The heater is provided above a lowermost portion of the fixing member facing the fixing member, and heats the fixing member according supplied power. A melting portion is provided in an energizing path between the electrostatic neutralizing member and ground, and melts in a case where a current exceeding a predetermined threshold flows.

### INCORPORATION BY REFERENCE

This application is based upon and claims the benefit of priority from the corresponding Japanese Patent Application No. 2021-175222 filed on Oct. 27, 2021, the entire contents of which are incorporated herein by reference.

### BACKGROUND

The present disclosure relates to an electrophotographic image forming apparatus

An electrophotographic image forming apparatus includes a fixing device that fixes a toner image transferred to a sheet onto the sheet. The fixing device includes a fixing member such as a fixing roller that comes in contact with a sheet to which a toner image has been transferred.

In this type of image forming apparatus, due to contact with the sheet, a surface of the fixing member may be charged with a polarity opposite to a charged polarity of the toner. In this case, a problem called static offset may occur in which part of the toner on a sheet passing through a contact position with the fixing member is transferred to the surface of the fixing member, and the transferred toner is then transferred to the next sheet passing through the contact position. On the other hand, an image forming apparatus that includes an electrostatic neutralizing member for neutralizing static electricity on the surface of the fixing member is known. The electrostatic neutralizing member is electrically grounded and provided so as to be in contact with the fixing member.

In addition, an image forming apparatus is known that shuts OFF a power supply in a case where an abnormal state in which a temperature of the fixing member that exceeds a predetermined value is detected.

### SUMMARY

An image forming apparatus according to an aspect of the present disclosure includes a fixing member, an electrostatic neutralizing member, a heater, and a melting portion. The fixing member comes into contact with a sheet to which a toner image has been transferred and fixes the toner image to the sheet. The electrostatic neutralizing member is electrically grounded and provided so as to be in contact with the fixing member. The heater is provided above a lowermost portion of the fixing member facing the fixing member, and heats the fixing member according supplied power. The melting portion is provided in an energizing path between the electrostatic neutralizing member and ground, and melts in a case where a current exceeding a predetermined threshold flows.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a configuration of an image forming apparatus of an embodiment according to the present disclosure.

FIG. 2 is a diagram showing a configuration of a fixing member of the image forming apparatus of an embodiment according to the present disclosure.

FIG. 3 is a diagram showing a configuration of a power supply portion of the image forming apparatus of an embodiment according to the present disclosure.

FIG. 4 is a diagram showing a configuration of the fixing member of the image forming apparatus of an embodiment according to the present disclosure.

FIG. 5 is a diagram showing a configuration of the fixing member of the image forming apparatus of another embodiment according to the present disclosure.

### DETAILED DESCRIPTION

Embodiments of the present disclosure will be described below with reference to the accompanying drawings. Note that the following embodiments are examples that embody a technique according to the present disclosure, and do not limit the technical scope of the present disclosure.

### Configuration of Image Forming Apparatus 100

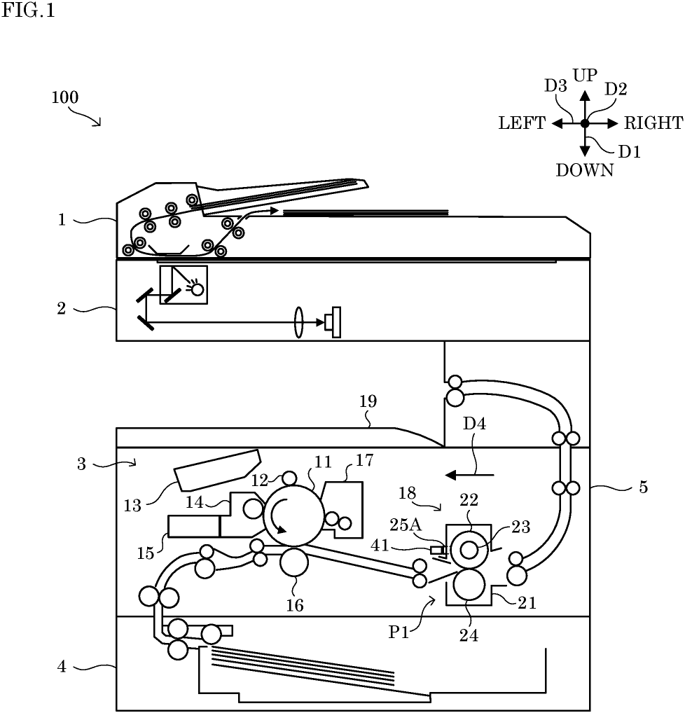

First, the configuration of an image forming apparatus 100 of an embodiment according to the present disclosure will be described with reference to FIG. 1. Here, FIG. 1 is a cross-sectional view showing the configuration of the image forming apparatus 100.

Note that for convenience of explanation, the vertical direction in the installation state (the state shown in FIG. 1) in which the image forming apparatus 100 can be used is defined as the up-down direction D1. In addition, the front-rear direction D2 and the left-right direction D3 are defined with the surface of the image forming apparatus 100 on the right side of the paper in FIG. 1 as being the right side surface.

The image forming apparatus 100 is a multifunction peripheral having a plurality of functions such as a scanning function that reads an image of a document sheet, a printing function that forms an image on a sheet based on image data, a fax function, a copying function, and the like. Note that the present disclosure may be applied to image forming apparatuses such as printers, fax machines, and copiers.

As shown in FIG. 1, the image forming apparatus 100 includes an auto document feeder (ADF) 1, an image reading portion 2, an image forming portion 3, a sheet feed portion 4, and a housing 5.

The ADF 1 conveys a document sheet as a reading target to be read by the scanning function. The ADF 1 includes a document sheet setting portion, a plurality of conveying rollers, a document sheet holder, and a sheet discharge portion.

The image reading portion 2 achieves the scanning function. The image reading portion 2 has a document sheet table, a light source, a plurality of mirrors, an optical lens, and a charge coupled device (CCD).

The image forming portion 3 achieves the printing function. More specifically, the image forming portion 3 forms an image by an electrophotographic method.

The sheet feed portion 4 conveys a sheet on which an image is formed by the image forming portion 3. The sheet feed portion 4 includes a sheet feed cassette and a plurality of conveying rollers.

The housing 5 houses the image forming portion 3 and the sheet feed portion 4. The housing 5 is formed in a substantially rectangular parallelepiped box shape. A sheet discharge tray 19 to which sheets on which images are formed by the image forming portion 3 are discharged is provided at an upper surface portion of the housing 5.

### Configuration of Image Forming Portion 3

Next, the configuration of the image forming portion 3 will be described with reference to FIG. 1.

As shown in FIG. 1, the image forming portion 3 includes a photoconductor drum 11, a charging roller 12, a laser scanning unit 13, a developing device 14, a toner container 15, a transfer roller 16, a cleaning device 17, a fixing device 18, and a sheet discharge tray 19.

The photoconductor drum 11 carries a toner image. The photoconductor drum 11 is provided so as to be rotatable in a direction of an arrow shown in FIG. 1.

The charging roller 12 charges an outer peripheral surface of the photoconductor drum 11 according to an application of a preset charging voltage. The charging roller 12 is provided so as to be in contact with the outer peripheral surface of the photoconductor drum 11.

The laser scanning unit 13, based on image data, emits light toward the outer peripheral surface of the photoconductor drum 11 charged by the charging roller 12. An electrostatic latent image is formed on the outer peripheral surface of the photoconductor drum 11 by being irradiated with light emitted from the laser scanning unit 13.

The developing device 14 makes visible (develops) the electrostatic latent image formed on the outer peripheral surface of the photoconductor drum 11 using toner. The developing device 14 includes a toner containing portion that contains toner, and a developing roller that supplies the toner contained in the toner containing portion to the photoconductor drum 11. A toner image is formed on the outer peripheral surface of the photoconductor drum 11 by the developing device 14.

The toner container 15 supplies toner to the developing device 14.

The transfer roller 16 transfers a toner image formed on the photoconductor drum 11 onto a sheet supplied by the sheet feed portion 4 according to application of a preset transfer voltage.

The cleaning device 17 cleans the outer peripheral surface of the photoconductor drum 11 after a toner image has been transferred by the transfer roller 16.

The fixing device 18 fixes a toner image that has been transferred onto a sheet by the transfer roller 16 onto the sheet.

The fixing device 18 is detachably provided in the housing 5. For example, the housing 5 is provided with an openable/closable cover portion (not shown) forming a right side surface. When the cover member is opened in a state in which the fixing device 18 is not mounted in the housing 5, a mounting position P1 (see FIG. 1) where the fixing device 18 is mounted is exposed. The fixing device 18 is mounted in a mounting direction D4 (see FIG. 1) at the exposed mounting position P1.

### Structure of Fixing Device 18

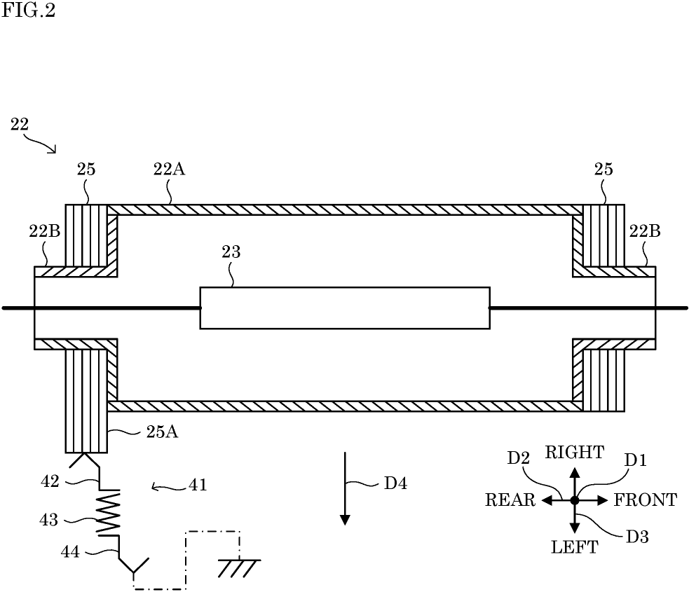

Next, configuration of the fixing device 18 will be described with reference to FIGS. 1 and 2. Here, FIG. 2 is a cross-sectional view showing the configuration of the fixing member 22. Note that FIG. 2 shows a cross section of the fixing member 22 taken along a plane perpendicular to the up-down direction D1. In addition, the thick line in FIG. 2 indicates an electric wire connected to a heater 23. Moreover, the dashed line in FIG. 2 indicates an energizing path from a contact portion 41 to ground.

As shown in FIGS. 1 and 2, the fixing device 18 includes a housing 21, a fixing member 22, a heater 23, a pressure member 24, and a bearing portion 25.

The housing 21 houses the fixing member 22, the pressure member 24, and the bearing portion 25.

The fixing member 22 comes in contact with a sheet to which a toner image has been transferred and fixes the toner image on the sheet.

More specifically, the fixing member 22 is a hollow roller member as shown in FIG. 2. The fixing member 22 includes a tubular portion 22A and shaft portions 22B. The tubular portion 22A is formed in a cylindrical shape from a metal such as aluminum, steel, or the like. An elastic layer formed of silicon rubber or the like, and a release layer formed of fluororesin such as PFA are laminated on an outer peripheral surface of the tubular portion 22A. The shaft portions 22B are provided at both ends of the tubular portion 22A. The shaft portions 22B form a rotating shaft of the fixing member 22. The shaft portions 22B are rotatably supported by bearing portions 25 supported by the housing 21.

The heater 23 is provided above the lowermost portion of the fixing member 22 so as to face the fixing member 22. The heater 23 heats the fixing member 22 according to supplied power.

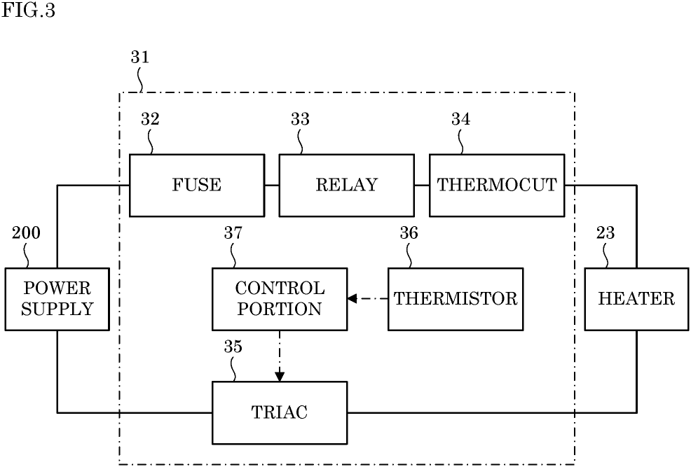

More specifically, the heater 23 is a halogen heater provided inside the fixing member 22. As shown in FIG. 2, the heater 23 is provided inside the tubular portion 22A so as to extend along the front-rear direction D2, which is the longitudinal direction of the tubular portion 22A. The heater 23 is provided so as to face the inner peripheral surface of the tubular portion 22A. The heater 23 radiates heat toward the inner peripheral surface of the tubular portion 22A to heat the tubular portion 22A from the inside. The heater 23 is driven by power supplied from the power supply portion 31 shown in FIG. 3. The power supply portion 31 is provided inside the housing 5.

The pressure member 24 is provided in contact with the fixing member 22 and presses a sheet passing between the pressure member 24 and the fixing member 22.

More specifically, the pressure member 24 is a roller member. For example, the pressure member 24 includes a tubular portion similar to that of the fixing member 22, and a shaft portion. The pressure member 24 is rotatably supported by the housing 21. The pressure member 24 is biased toward the fixing member 22 by a biasing member (not shown). Thus, a fixing nip portion is formed between the fixing member 22 and the pressure member 24.

In the fixing device 18, the fixing member 22 rotates by receiving a rotational driving force supplied from a drive portion (not shown). Thus, the pressure member 24 that is in pressure contact with the fixing member 22 is driven and rotated. In addition, a driving force directed toward a downstream side (sheet discharge tray 19 side) in the conveying direction is applied to the sheet passing through the fixing nip portion. A sheet onto which a toner image has been transferred is heated and pressed by the fixing member 22 and the pressure member 24 when passing through the fixing nip portion. Thus, the toner image transferred to the sheet is fixed on the sheet. Note that instead of the fixing member 22, the pressure member 24 may be rotated by receiving a rotational driving force supplied from the drive portion.

The bearing portion 25 is a slide bearing (bushing) that rotatably supports the shaft portion 22B of the fixing member 22.

Here, in the image forming apparatus 100, the surface of the fixing member 22 may be charged with a polarity opposite to the charging polarity of the toner due to contact with the sheet. More specifically, in the image forming apparatus 100, an image is formed using toner charged with a positive polarity. In addition, in the image forming apparatus 100, the surface of the fixing member 22 may be charged with a negative polarity due to contact with the sheet.

In a case where the surface of the fixing member 22 is charged with a polarity opposite to the charged polarity of the toner, a problem called electrostatic offset occurs in which part of the toner on the sheet passing through the fixing nip portion is transferred to the surface of the fixing member 22, and the transferred toner is then transferred to the next sheet passing through the fixing nip. On the other hand, in the image forming apparatus 100, the surface of the fixing member 22 is electrostatically neutralized by the bearing portions 25.

More specifically, the bearing portions 25 are electrically grounded and provided in contact with the fixing member 22. The bearing portions 25 are an example of the electrostatic neutralizing member according to the present disclosure.

For example, the bearing portions 25 are formed of a conductive resin material. As shown in FIG. 2, the bearing portions 25 are provided corresponding to each of the shaft portions 22B of the fixing member 22. In addition, each of the bearing portions 25 is provided in contact with an end portion in the lengthwise direction of the tubular portion 22A. As shown in FIG. 2, of the two bearing portions 25, the bearing portion 25 located on a rear side is provided with a projecting portion 25A projecting in the mounting direction D4 of the fixing device 18. The projecting portion 25A is exposed outside the housing 21 (see FIG. 1). The projecting portion 25A is electrically connected to a ground plate (not shown) via a contact portion 41 shown in FIG. 2. Thereby, the bearing portion 25 is electrically grounded.

### Configuration of Power Supply Portion 31

Next, the configuration of the power supply portion 31 will be described with reference to FIG. 3. Here, FIG. 3 is a block diagram showing the configuration of the power supply portion 31. Note that the dashed line in FIG. 3 indicates the power supply portion 31. In addition, the dashed-dotted line with an arrow in FIG. 3 indicates an electric signal to be output.

The power supply portion 31 supplies power of the power supply 200 to the heater 23. For example, the power supply 200 is a commercial power supply that outputs an AC voltage of 100V. The power supply portion 31 is connected to the power supply 200 via a power plug.

As shown in FIG. 3, the power supply portion 31 includes a fuse 32, a relay 33, a thermocut 34, a triac 35, a thermistor 36, and a control portion 37.

The fuse 32 blows when a current exceeding a predetermined limit value flows, and disconnects the energizing path between the power supply 200 and the heater 23.

The relay 33 can switch connection and disconnection of the energizing path between the power supply 200 and the heater 23. For example, the relay 33 disconnects the energizing path between the power supply 200 and the heater 23 in a case where the cover member is opened.

The thermocut 34 disconnects the energizing path between power supply 200 and heater 23 in a case where the temperature of the fixing member 22 exceeds a predetermined reference temperature.

The triac 35 is a semiconductor switch capable of switching the connection and disconnection of the energizing path between the power supply 200 and the heater 23.

The thermistor 36 is provided in contact with the fixing member 22, and detects a temperature of the fixing member 22. The thermistor 36 outputs an electrical signal corresponding to the temperature of the fixing member 22.

The control portion 37 controls driving of the heater 23 based on the electrical signal output from the thermistor 36. More specifically, the control portion 37 controls power supply to the heater 23 so that the temperature of the fixing member 22 detected by the thermistor 36 becomes a predetermined target temperature. The control portion 37 uses the triac 35 to control the power supply to the heater 23.

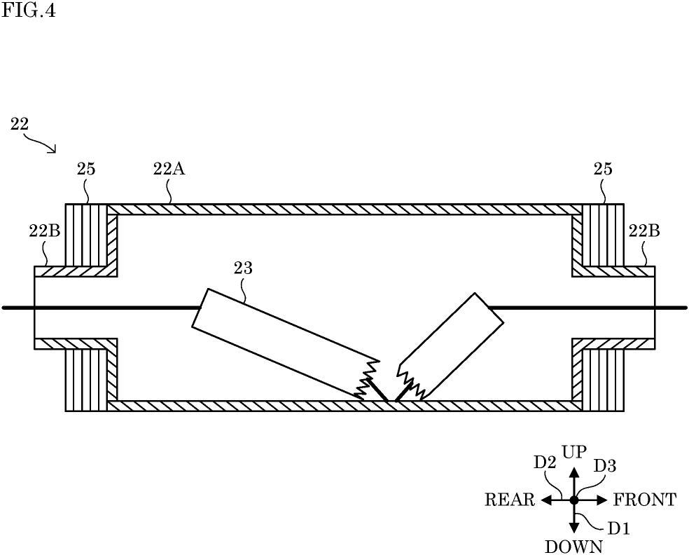

The heater 23 that heats the fixing member 22 may become damaged, resulting in current from the power supply 200 that supplies power to the heater 23 flowing through the bearing portions 25. For example, as shown in FIG. 4, in a case where the tube of the heater 23 provided inside the fixing member 22 is broken and a wire of the heater 23 comes in contact with the inner peripheral surface of the fixing member 22, current from the power supply 200 flows through the bearing portions 25. Note that FIG. 4 shows a cross section of the fixing member 22 taken along a plane orthogonal to the left-right direction D3. In a case where current from the power supply 200 flows through the bearing portions 25, high temperature may occur in the bearing portions 25, which have a high electrical resistance, and cause a fire.

However, in a conventional image forming apparatus, it is not possible to suppress high temperature from occurring in the bearing portions 25 due to current from the power supply 200 flowing through the bearing portions 25. On the other hand, in the image forming apparatus 100 of an embodiment according to the present disclosure, it is possible to suppress high temperature from occurring in the bearing portions 25 that perform electrostatic neutralization of the fixing member 22 as described below.

### Configuration of Contact Portion 41

Next, the configuration of the contact portion 41 will be described with reference to FIG. 1 and FIG. 2.

The contact portion 41 is provided at a mounting position P1 (see FIG. 1) of the fixing device 18 in the housing 5. The contact portion 41 comes into contact with the projecting portion 25A of the bearing portion 25 of the fixing device 18 mounted to the housing 5, and grounds the bearing portion 25. The contact portion 41 presses the projecting portion 25A of the fixing device 18 mounted to the mounting position P1 in a direction opposite to the mounting direction D4.

As shown in FIG. 2, the contact portion 41 includes a first leaf spring 42, a coil spring 43, and a second leaf spring 44. The first leaf spring 42, the coil spring 43, and the second leaf spring 44 are arranged side by side along the mounting direction D4. The first leaf spring 42, the coil spring 43, and the second leaf spring 44 constitute an energizing path for current flowing between the bearing portion 25 and the ground plate.

The first leaf spring 42 comes in contact with the projecting portion 25A of the fixing device 18 mounted to the mounting position P1. The first leaf spring 42 is made of metal such as SUS. The first leaf spring 42 is provided so as to be able to move along the mounting direction D4.

The coil spring 43 presses the bearing portion 25 of the fixing device 18 mounted to the housing 5 in a direction opposite to the mounting direction D4. The coil spring 43 is provided between the first leaf spring 42 and the second leaf spring 44. The coil spring 43 is a compression coil spring wound around an axis along the mounting direction D4. The coil spring 43 is composed of a metal wire material. The coil spring 43 presses the bearing portion 25 via the first leaf spring 42. One end of the coil spring 43 in the direction of expansion and contraction is fixed to the first leaf spring 42, and the other end is fixed to the second leaf spring 44.

The second leaf spring 44 is electrically connected to the ground plate. The second leaf spring 44 is made of metal such as SUS. The second leaf spring 44 is fixed to the housing 5.

The coil spring 43 melts in a case where a current exceeding a predetermined threshold value flows. The coil spring 43 is an example of a melting portion according to the present disclosure.

Here, the threshold value is determined based on current flowing through the bearing portion 25 in a case where the energizing path between the power supply 200 and the heater 23 is connected to ground via the bearing portion 25, that is, when grounded. In addition, the threshold value is set to a value higher than a current value of current that flows during electrostatic neutralization of the fixing member 22 by the bearing portion 25. For example, by preparing a damaged heater 23 as shown in FIG. 4 and measuring the electric current flowing through the bearing portion 25 in a state in which a wire of the heater 23 is in contact with the inner peripheral surface of the fixing member 22, it is possible to set the threshold value based on the measurement result.

More specifically, the wire material of the coil spring 43 has a cross-sectional size (cross-sectional area) smaller than a specific size corresponding to the threshold value.

Here, the specific size is the maximum size among the cross-sectional sizes of the wire material that melts or breaks when the threshold current flows. The specific size varies depending on the type of metal of the wire. For example, the specific size may be specified by preparing a plurality of wire materials having different cross-sectional sizes, and conducting an experiment in which the threshold current is applied to each of the prepared wire materials to confirm whether or not the wire is melted or broken.

As described above, in the image forming apparatus 100, in a case where the heater 23 is damaged and the current of the power supply 200 flows through the bearing portion 25, the coil spring 43 melts. Thus, the energizing path between the bearing portion 25 and the ground plate is disconnected, and therefore the current from the power supply 200 can be suppressed from flowing to the bearing portion 25. Therefore, it is possible to suppress high temperature from occurring in the bearing portion 25.

Note that the contact portion 41 may not include the coil spring 43.

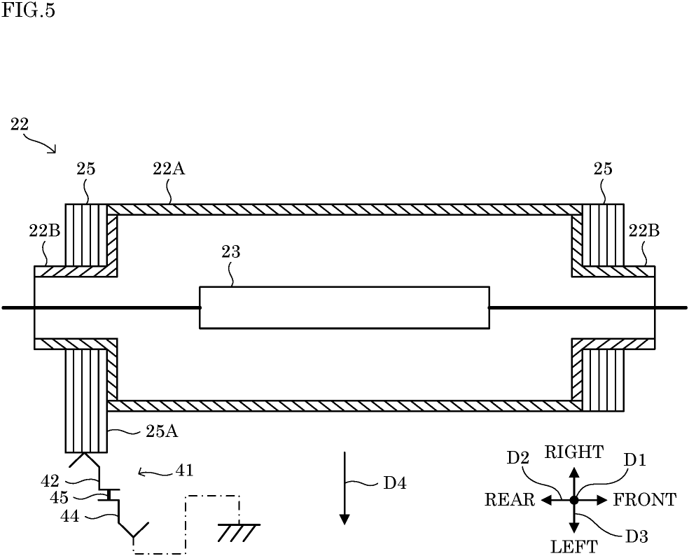

For example, the contact portion 41 may include a connecting portion 45 shown in FIG. 5 instead of the coil spring 43. The connecting portion 45 connects the first leaf spring 42 and the second leaf spring 44 between the first leaf spring 42 and the second leaf spring 44. The connecting portion 45 extends in a facing direction (left-right direction D3) in which the first leaf spring 42 and the second leaf spring 44 face each other. One end of the connecting portion 45 in the facing direction is fixed to the first leaf spring 42, and the other end is fixed to the second leaf spring 44. The connecting portion 45 is made of metal. The cross-sectional size of the connection portion 45 perpendicular to the facing direction is smaller than the specific size. The first leaf spring 42, the second leaf spring 44, and the connecting portion may be integrally formed, or may be separate members. In a case where the connecting portion 45 is provided instead of the coil spring 43, the first leaf spring 42 may be provided so as to be fixed to the housing 5, and may press the bearing portion 25 of the fixing device 18 mounted to the housing 5 in a direction opposite to the mounting direction D4. The connecting portion 45 is another example of a melting portion according to the present disclosure.

In addition, a fuse that melts in a case where a current exceeding the threshold value flows may be provided on the energizing path between the bearing portion 25 and the ground plate, separately from the contact portion 41. The fuse is another example of a melting portion according to the present disclosure. In this case, the fixing device 18 may be provided in the housing 5 so as not to be removable. In addition, the image forming apparatus 100 may not include the contact portion 41.

Further, in addition to the bearing portion 25, a contact member may be provided to electrostatically neutralize the surface of the fixing member 22. The contact member is electrically grounded and may be provided so as to be in contact with the fixing member 22. The contact member is another example of an electrostatic neutralizing member according to the present disclosure.

In addition, the heater 23 may be provided on an upper side of the fixing member 22 so as to face the outer peripheral surface of the fixing member 22. Moreover, the heater 23 is not limited to being a halogen heater, and may be another type of heater. Further, the fixing member 22 is not limited to being a roller member, and may be a member having another shape such as a belt member.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. An image forming apparatus, comprising:
a fixing member configured to come in contact with a sheet to which a toner image has been transferred and to fix the toner image to the sheet;
an electrostatic neutralizing member that is electrically grounded and provided so as to be in contact with the fixing member;
a heater provided above a lowermost portion of the fixing member, facing the fixing member, and configured to heat the fixing member according supplied power; and
a melting portion provided in an energizing path between the electrostatic neutralizing member and ground and configured to melt in a case where a current exceeding a predetermined threshold flows.

2. The image forming apparatus according to claim 1, wherein
the fixing member is a hollow roller member; and
the heater is a halogen heater provided inside the fixing member.

3. The image forming apparatus according to claim 2, wherein
the electrostatic neutralizing member also serves as a bearing portion that rotatably supports a rotating shaft of the fixing member.

4. The image forming apparatus according to claim 2, further comprising:
a fixing device that includes the fixing member and the electrostatic neutralizing member and configured to be attachable to and detachable from a housing of the image forming apparatus; and
a contact portion provided at a mounting position of the fixing device in the housing and configured to come in contact with the electrostatic neutralizing member in the fixing device mounted to the housing, and to ground the electrostatic neutralizing member; and wherein
the melting portion is included in the contact portion.

5. The image forming apparatus according to claim 4, wherein
the melting portion is a coil spring configured to press the electrostatic neutralizing member in the fixing device mounted to the housing in a direction opposite to a mounting direction of the fixing device.
